(19) United States
(12) Patent Application Publication
(10) Pub. No.: US 2010/0071771 A1
(43) Pub. Date: Mar. 25, 2010

(54) High altitude atmospheric injection system and method

(75) Inventors: Alistair K. Chan, Bainbridge Island, WA (US); Roderick A. Hyde, Redmond, WA (US); Nathan P. Myhrvold, Bellevue, WA (US); Clarence T. Tegreene, Bellevue, WA (US); Lowell L. Wood, JR., Bellevue, WA (US)

Correspondence Address: SEARETE LLC;CLARENCE T. TEGREENE, 1756 - 114TH AVE., S.E., SUITE 110, BELLEVUE, WA, 98004, US

(73) Assignee: Searete LLC, a limited liability corporation of the State of Delaware

(21) Appl. No.: 12/589,504

(22) Filed: Oct. 22, 2009

Related U.S. Application Data
(63) Continuation-in-part of application No. 11/788,389, filed on Apr. 18, 2007.
Application No. 11/788,389 is a continuation-in-part of application No. 11/788,372, filed on Apr. 18, 2007.
Application No. 11/788,372 is a continuation-in-part of application No. 11/788,394, filed on Apr. 18, 2007.
Application No. 11/788,394 is a continuation-in-part of application No. 11/788,383, filed on Apr. 18, 2007.

(51) Int. Cl. G05D 7/00; F16L 9/00; B64C 3/00; B64B 1/40; B61B 13/00; B61D 17/02

(52) U.S. Cl. 137/1; 138/177; 244/35 R; 244/31; 104/307; 52/84

(57) ABSTRACT

A system and method is described generally for affecting atmospheric change. The system and method include providing a high altitude conduit or track. The system and method also include providing a first material through the conduit or via a payload delivery system. Further, the system and method include expelling the first material into the atmosphere at high altitude.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)).

1. For purposes of the USPTO extra-statutory requirements, the present application constitutes a continuation in part of currently co-pending U.S. patent application entitled HIGH ALTITUDE STRUCTURES AND RELATED METHODS, naming Alistair K. Chan, Roderick A. Hyde, Nathan P. Myhrvold, Lowell L. Wood, Jr., and Clarence T. Tegreene as inventors, U.S. application Ser. No. 11/788,389, filed Apr. 18, 2007.
2. For purposes of the USPTO extra-statutory requirements, the present application constitutes a continuation in part of currently co-pending U.S. patent application entitled HIGH ALTITUDE STRUCTURES CONTROL SYSTEM AND RELATED METHODS, naming Alistair K. Chan, Roderick A. Hyde, Nathan P. Myhrvold, Lowell L. Wood, Jr., and Clarence T. Tegreene as inventors, U.S. application Ser. No. 11/788,372, filed Apr. 18, 2007.
3. For purposes of the USPTO extra-statutory requirements, the present application constitutes a continuation in part of currently co-pending U.S. patent application entitled HIGH ALTITUDE PAYLOAD STRUCTURES AND RELATED METHODS, naming Alistair K. Chan, Roderick A. Hyde, Nathan P. Myhrvold, Lowell L. Wood, Jr., and Clarence T. Tegreene as inventors, U.S. application Ser. No. 11/788,394, filed Apr. 18, 2007.
4. For purposes of the USPTO extra-statutory requirements, the present application constitutes a continuation in part of currently co-pending U.S. patent application entitled HIGH ALTITUDE ATMOSPHERIC ALTERATION SYSTEM AND METHODS, naming Alistair K. Chan, Roderick A. Hyde, Nathan P. Myhrvold, Lowell L. Wood, Jr., and Clarence T. Tegreene as inventors, U.S. application Ser. No. 11/788,383, filed Apr. 18, 2007.

### BACKGROUND

The description herein generally relates to the field of high altitude conduits and high altitude structures capable of many applications including affecting changes in the atmosphere.

Conventionally, there is a need for high altitude structures for high altitude applications, such as but not limited to weather modification, global temperature change, atmospheric management, venting, etc.

### SUMMARY

In one aspect, a method of affecting atmospheric change includes providing a high altitude conduit supported by lifting forces, and buoyancy force generated by at least one buoyant lifting body coupled to the high altitude conduit. The method also includes providing a first material through the conduit. Further, the method includes expelling the first material through at least one conduit opening into the atmosphere at high altitude.

In yet another aspect, a method of delivering a payload includes providing at least one high altitude track supported by lifting forces, the lifting forces coming from at least one of buoyancy effects a carrier, aerodynamic lifting surfaces, propulsive devices, or multiple carriers. The method also includes running a payload carrier along the track carrying a payload. Further, the method includes expelling at least a first material from the payload into the atmosphere at high altitude.

In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

In one aspect, a system for providing material to the atmosphere includes an elongate conduit structure extending into the atmosphere and being held aloft by lifting forces and buoyant forces generated by at least one buoyant lifting body coupled to the high altitude conduit. The system also includes an introducer configured to provide a first material into the interior of the conduit. Further, the system comprises at least one exit aperture configured to expel the first material into the atmosphere.

In addition to the foregoing, other system aspects are described in the claims, drawings, and text forming a part of the present disclosure.

In addition to the foregoing, various other method and/or system and/or program product aspects are set forth and described in the teachings such as text (e.g., claims and/or detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

The foregoing summary is illustrative only and is not intended to be in any way limiting. In addition to the illustrative aspects, embodiments, and features described above, further aspects, embodiments, and features will become apparent by reference to the drawings and the following detailed description, of which:

FIG. 1 is an exemplary diagram of a generalized high altitude conduit.

FIG. 2 is an exemplary diagram of a cross sectional configuration of a high-altitude conduit.

FIG. 3 is an exemplary diagram of a cross sectional configuration of a high-altitude conduit showing supporting elements.

FIG. 4 is an exemplary diagram of an alternative configuration of a high altitude conduit having multiple conduit exits.

FIG. 5 is an exemplary diagram of a high altitude conduit depicting potential height thereof.

FIG. 6 is an exemplary diagram of a high altitude conduit being supported at least in part by an orbital anchor.

FIG. 7 is an exemplary diagram of a high altitude conduit being supported at least in part by carriers.

FIG. 8 is an exemplary process diagram of process to use a high altitude conduit to affect atmospheric change.

FIG. 9 is an exemplary process diagram of a process to use a high altitude conduit to affect terrestrial temperature change or to implement cloud seeding.

FIG. 10 is an exemplary process diagram of a process to track material distributed by a high altitude conduit.

FIG. 11 is an exemplary diagram of a high altitude conduit being supported by a buoyant airfoil or other lifting surface.

FIG. 12 is an exemplary diagram of a high altitude elevator and delivery system.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

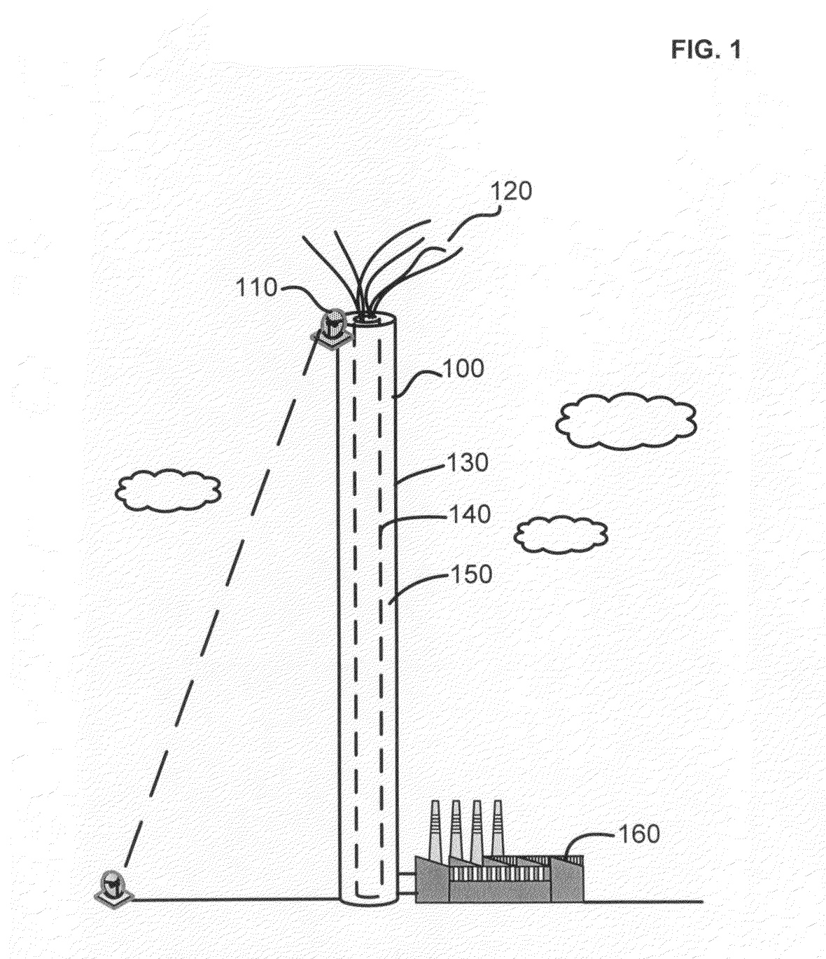

Referring now to FIG. 1, a high-altitude structure 100 is depicted. High altitude structure 100 includes but is not limited to any of a variety of materials which may be relatively lightweight, strong, and be capable of standing aloft in a variety of atmospheric, weather-related, and heating conditions. Further, structure 100 may be capable of being applied in a variety of environments and for a variety of applications. Structure 100 may be used in a variety of ways including as a supporting structure for equipment, such as but not limited to antenna 110, as a vent for exhaust gases 120, or as a particulate or gas introducer, or the like. In the exemplary embodiment depicted in FIG. 1, structure 100 is an approximately cylindrical shape forming an elongated cannula having an exterior wall 130 surrounding an interior wall 140. In a particular exemplary embodiment a void 150 may be formed between exterior wall 130 and interior wall 140. The structure may be supported by introducing a gas into void 150 which may be lighter than the ambient air surrounding the structure. Gas introduced into void 150 may come from any of a variety of sources. In a particular exemplary embodiment, gas may come from a manufacturing facility 160 where gas may be manufactured for the purpose of supporting conduit 150 or the gas may be exhaust gasses from a manufacturing process at facility 160. In accordance with alternative embodiments, the structure of the voids and conduits may vary and may include any number of and combination of voids and conduits. Also, material flow in the voids and conduits may be controlled. In an alternative embodiment, there may be interconnections between the voids and conduits such that material flow may be created between the voids and conduits and/or between voids and/or between conduits. Although specific shapes, cross sections, and relative dimensions of the voids and conduits are depicted, the embodiments are not limited but may be made in any of a variety of shapes, cross sections, and relative dimensions. Further, the shapes, sizes, materials, relative dimensions, etc., may vary by location on the structure or alternatively may be varied in time. In an exemplary embodiment, the material flow may come from any of a variety of sources, including but not limited to a reservoir, a storage container, the atmosphere, an exhaust or waste material flow, etc.

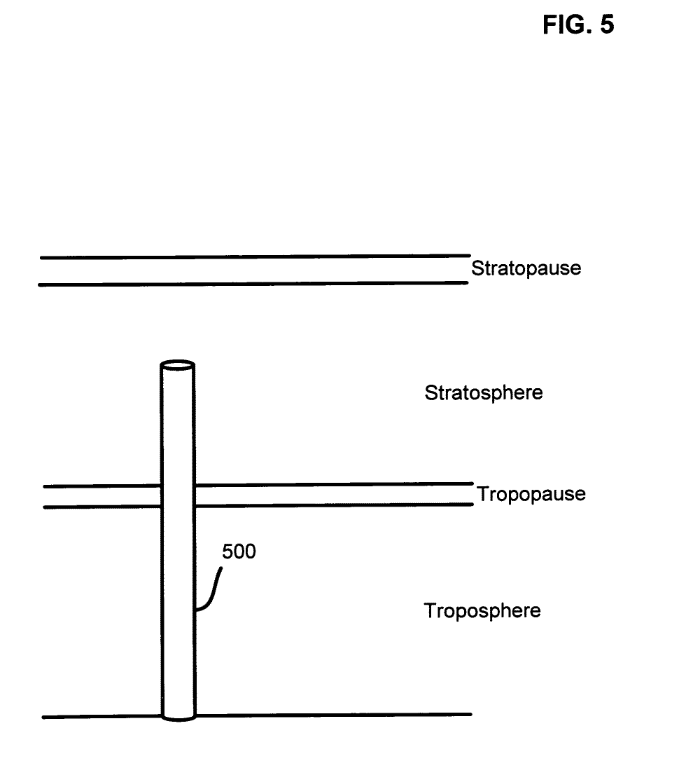

High altitude conduit 100 is a conduit which may exceed the height of chimneys and like structures which are built from conventional building materials like concrete, steel, glass, wood, etc. which carry considerable weight. In one exemplary embodiment conduit 100 may reach higher than one kilometer above its base. In other exemplary embodiments the conduit may be formed to reach much greater heights. For example, referring to FIG. 5, a conduit 500 is depicted. Conduit 500 extends to high altitudes. In an exemplary embodiment, conduit 500 extends into the stratosphere (approximately 15 km to 50 km above sea level). In other exemplary embodiments conduit 500 may extend to other altitudes above or below the stratosphere. In exemplary embodiments, high altitude conduit 100 may be coupled at its base end to the surface of the earth or other planet. The surface may include but is not limited to the ground, on the water, above the ground on a supporting structure, underground, underwater, and the like.

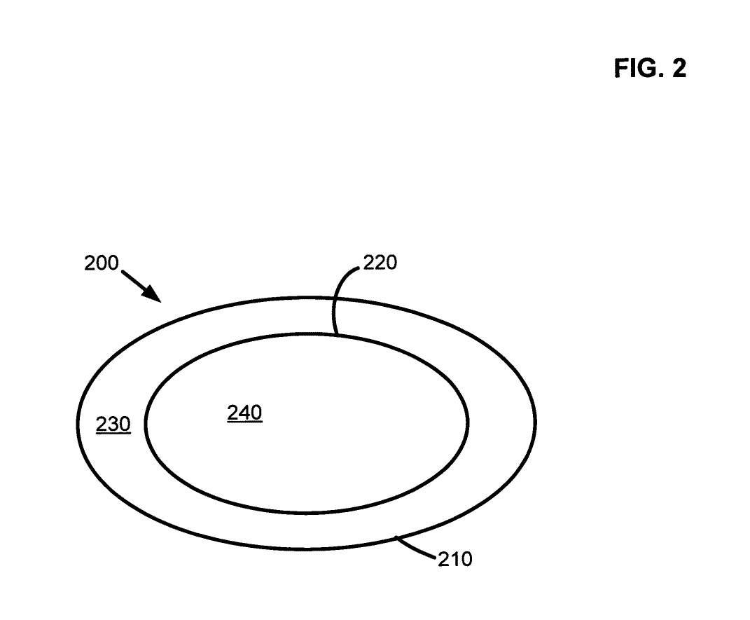

Referring now to FIG. 2, a cross section of an exemplary high altitude conduit 200 is depicted. High altitude conduit 200 includes a first outer material layer 210 and a second interior material layer 220. The two material layers form a space 230 or void between the two layers. In one exemplary embodiment, space 230 may be filled with a gas that is lighter than the surrounding atmospheric air. The gas may provide buoyancy to the conduit. The gas in space 230 may also be provided under pressure such that it helps to maintain the shape of conduit 200. Gas in space 230 may be vented in a variety of manners including but not limited to through seams, vents, and holes, etc. The gas may be provided to conduit 200 by an introducer which may be in any of a variety of forms, including, but not limited to an exhaust outlet from a manufacturing facility or other industrial business, an outlet from a gas tank or other gas producing device, etc. In an exemplary embodiment interior material layer 220 forms an elongated tube or cannula having an interior lumen 240. Interior lumen 240 may be used for a variety of purposes including but not limited to providing gasses and/or particulate to the atmosphere at a given altitude, providing an outlet for exhaust gasses at a given altitude. Thus, conduit 200 may be used as a high atmospheric chimney for a manufacturing plant. Alternatively conduit 200 may be used to provide gasses and particulate into the atmosphere in an attempt to influence global warming or global cooling. It has been shown that certain gasses and/or particulate in the air may reflect incoming sunlight thereby reducing the amount of heat absorbed by the earth. Also, it has been shown that certain other gasses and/or particulate in the air may tend to trap heat close to the Earth's surface, thereby increasing the amount of heat absorbed by the Earth. By controlling the amount and type of gasses and/or particulate placed into the atmosphere, it may be possible to control to some extent the heating of the Earth. Delivery of such gasses and/or particulate may be provided by the use of high altitude conduit systems, such as are described here.

In accordance with other exemplary embodiments, the gas used to support conduit 100 of FIG. 1 may be any of a large variety of gasses including but not limited to hydrogen gas, helium gas, heated gas, exhaust gasses, etc. The introducer of the gas into the void for supporting conduit 100 may function to not only provide the gas but may also be used to pressurize the gas. Referring to FIG. 2, in one exemplary embodiment void 230 may be closed at the top of the conduit by a cap or sheet of material which substantially couples material layer 210 to material layer 220. In one exemplary form, the cap or sheet of material may include one or more holes that act as vents for the void 230. It should however be noted that any of a large variety of methods and structures may be used to support conduit 100 and further that conduit 100 which is depicted in FIG. 1 as a conduit may be representative of any of a variety of high altitude structures not limited to conduits.

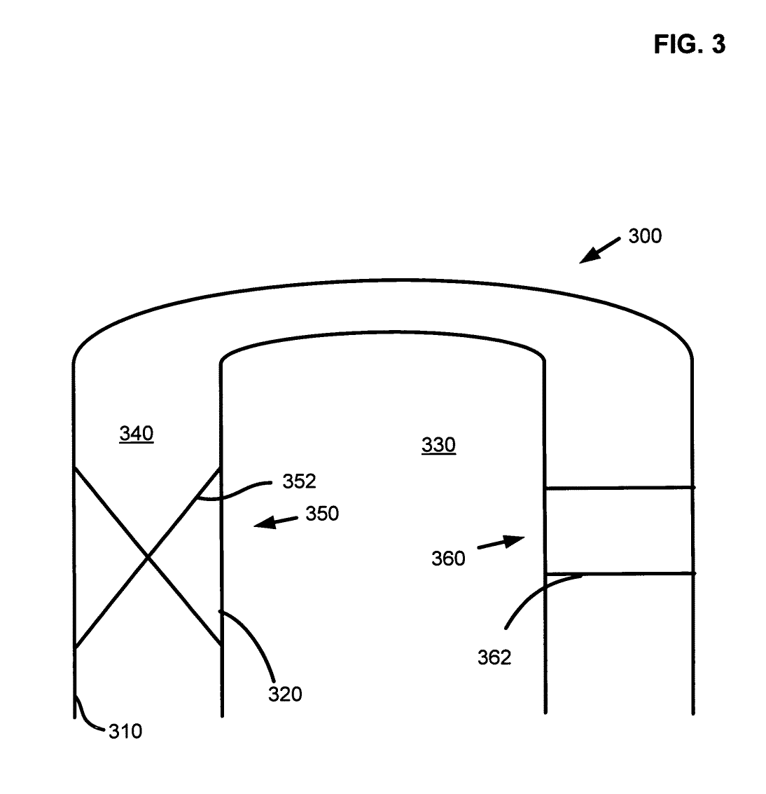

Referring now to FIG. 3, a cross section of a conduit 300 is depicted. Conduit 330 includes an outer material layer 310, and an inner material layer 320. Inner material layer 320 forms an annular or other closed shape to form a lumen 330. In an exemplary embodiment, a void 340 is defined by outer layer 310 and inner layer 320. In an exemplary embodiment, because conduit 300 may be of a very elongated shape and may be formed from lightweight materials, a reinforcement or support structure may be needed to give conduit 300 at least one of shape and strength. In one exemplary embodiment, the reinforcement structure may include supporting elements coupled to at least one of outer layer 310 or inner layer 320. For example, FIG. 3 depicts exemplary supporting structures 350 and 360. Supporting elements 350 may be cross braces formed of a lightweight material including but not limited to metals and metal alloys, composites, and plastics. In one exemplary embodiment, the materials used for the supporting rib structures may be the same as those used for the conduit albeit in different shape and form. Structure 350 is depicted having cross braces 352 that extend between and are coupled to the inner and outer layers 310 and 320. In another exemplary embodiment the support structure 360 may comprise radially extending braces 362. Further other supporting configurations may be used, such as but not limited to annular ring structures coupled to at least one of outer layer 310 and inner layer 320, lengthwise rib structures, helical rib structures, etc. Any of a variety of support structures may be used to help maintain a substantially upright orientation of structure 300 and further to support payloads which may be coupled thereto.

Conduit 100 and like conduits may be formed of any of a variety of relatively strong and lightweight materials, including but not limited to Mylar, ripstop nylon, Zylon, nanomaterials, latex, Chloroprene, plastic film, polyester fiber, etc. Other materials may similarly be used. Further materials may be combined in various combinations in order to achieve the performance characteristics required and desired. Conduit 100 may be formed of multiple layers of material and may include thermal insulation and the like.

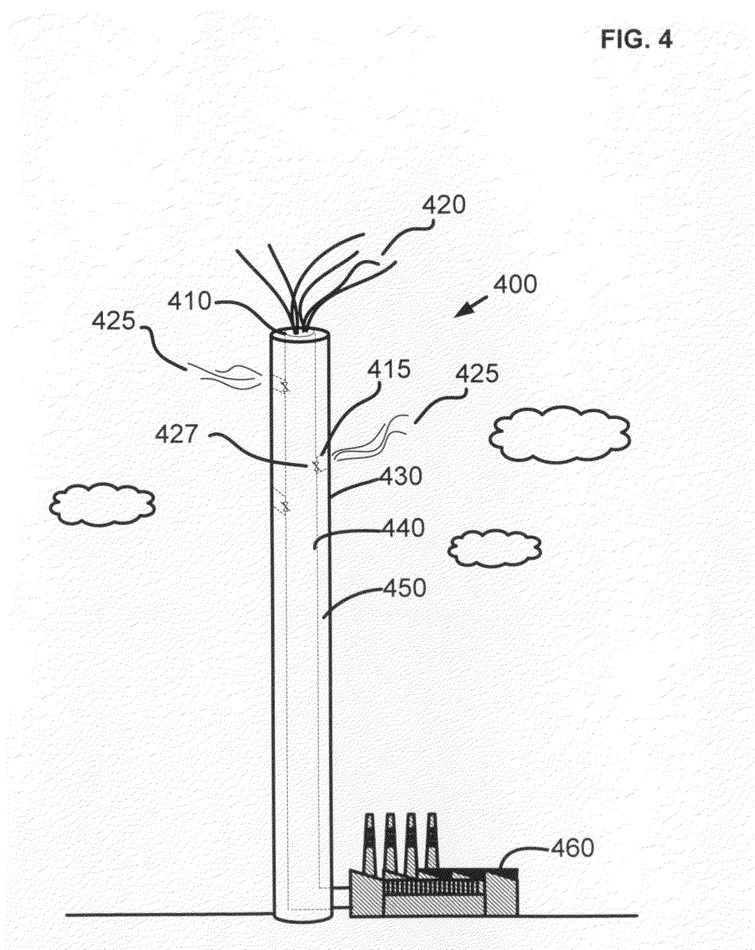

Referring now to FIG. 4, a high-altitude structure 400 is depicted. High altitude structure 400 includes but is not limited to any of a variety of materials which may be relatively lightweight, strong, and be capable of standing aloft in a variety of atmospheric, weather-related, and heating conditions. Further, structure 400 may be capable of being applied in a variety of environments and for a variety of applications including injecting or expelling certain materials into the atmosphere at various high altitudes for the purpose of affecting atmospheric change either locally or globally. Structure 400 may also and simultaneously be used in a variety of ways including as a supporting structure for equipment which may be attached to structure 400, as a vent for exhaust gases, or as a particulate or gas introducer, or the like. In the exemplary embodiment depicted in FIG. 4, structure 400 has an approximately cylindrical shape forming an elongated cannula having an exterior wall 430 surrounding an interior wall 440. In a particular exemplary embodiment a void 450 may be formed between exterior wall 430 and interior wall 440. The structure may be supported by introducing a gas into void 450 which may be lighter than the ambient air surrounding the structure. Gas introduced into void 450 may come from any of a variety of sources. In the embodiment depicted, a conduit exit 410 is formed at the top of conduit 400. Gasses or other materials including but not limited to solids, liquids, aerosols, mixtures, suspensions, and the like may be expelled from exit 410. Further, a conduit structure may have more than one exit at different altitudes, such as but not limited to exits such as exit 415 from which material may be expelled in a stream 425 as controlled by a valve 427. In a particular exemplary embodiment, the material or alternatively the lighter than air gas in void 450 may come from a manufacturing facility 460 where gas may be manufactured for the purpose of supporting conduit 450 or the gas may be exhaust gasses from a manufacturing process at facility 460 such as but not limited to a fossil fuel burning process.

Referring now to FIG. 5, a high altitude conduit 500 is depicted. Conduit 500 is depicted as extending into the stratosphere. Typically, the tropopause which transitions the atmosphere to the stratosphere occurs at approximately 15 kilometers above sea level. The stratopause, which defines the upper boundary of the stratosphere occurs at approximately 50 kilometers above sea level. In accordance with an exemplary embodiment, as shown conduit 500 extends into the stratosphere. Although facility may be provided by having conduit 500 extending into the stratosphere, other heights of conduit 500 may be useful as well. For example, it may be desirable to have a conduit extend at almost any height within the troposphere. It may also be useful to have conduits which extend beyond the stratosphere.

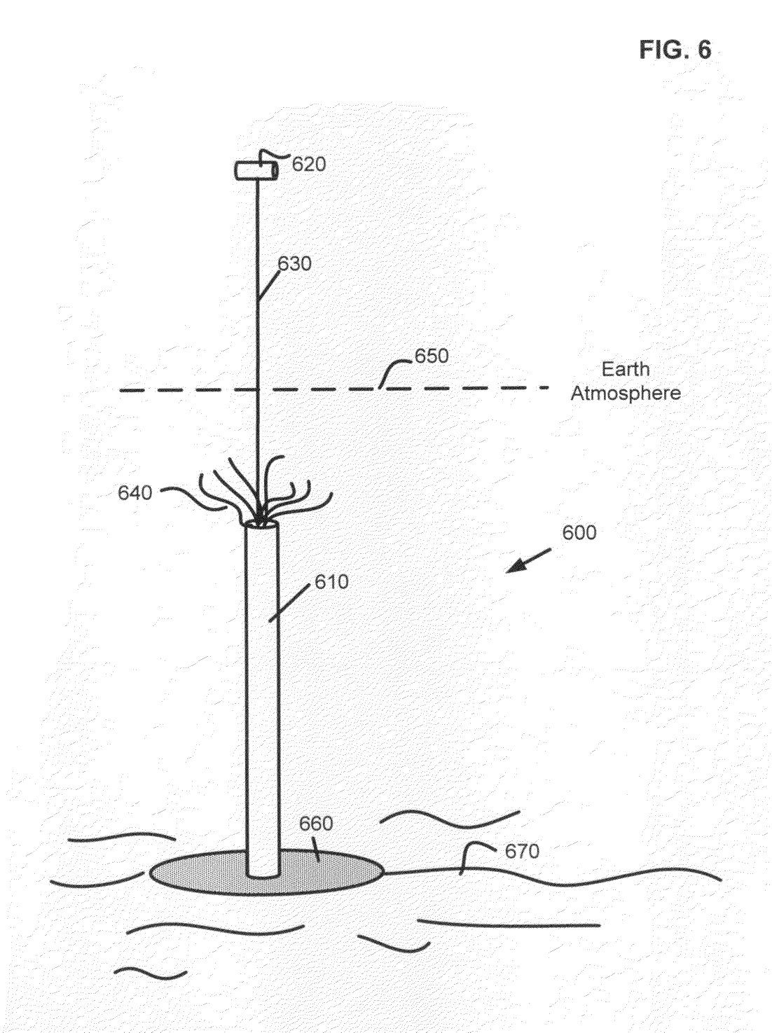

Referring now to FIG. 6, a high altitude structure 600 is depicted. High altitude structure 600 is formed of a material 610 that extends in a substantially upward direction. An orbital anchor (satellite or other orbiting body) supports material 610 by a tether 630 coupled between material 610 and orbital anchor 620. In an exemplary embodiment, anchor 620 is, while anchored via tether 630 to material 610, in a geosynchronous orbit (powered or unpowered and controlled or uncontrolled) about the earth or other planetary body. The geosynchronous orbit would be outside of the majority of earth's atmosphere represented by line 650. In an exemplary embodiment, a material 640 may be expelled from the conduit. High altitude structure 600 has essentially the same function as that discussed with reference to FIG. 4 in that it may be used to affect climate change and/or atmospheric changes either locally or globally. Tether 630 may be formed of any of a variety of materials having a high strength to weight ratio including but not limited to carbon nanotube fibers. A base 660 of structure 600 may be supported on the ground, underground, underwater, in the air or, as depicted floating on a body of water 670. Allowing the base 660 to move may make it easier to control the top of the structure 600 as variance of tension of the tether 630 may occur. Also having the ability to have the base movable may be advantageous in allowing less stress on the structure itself. One advantage of having base 660 being on the water may be that ocean water may be used in creating the material to be expelled. For example, it may be desirable to use ocean water to create halide mists that may be carried up the conduit structure and expelled into the atmosphere. The introduction of halide mists into the atmosphere may aid in creating an albedo effect in which some solar energy impinging on the Earth's atmosphere is reflected. This albedo effect may aid in reducing the effect of global warming.

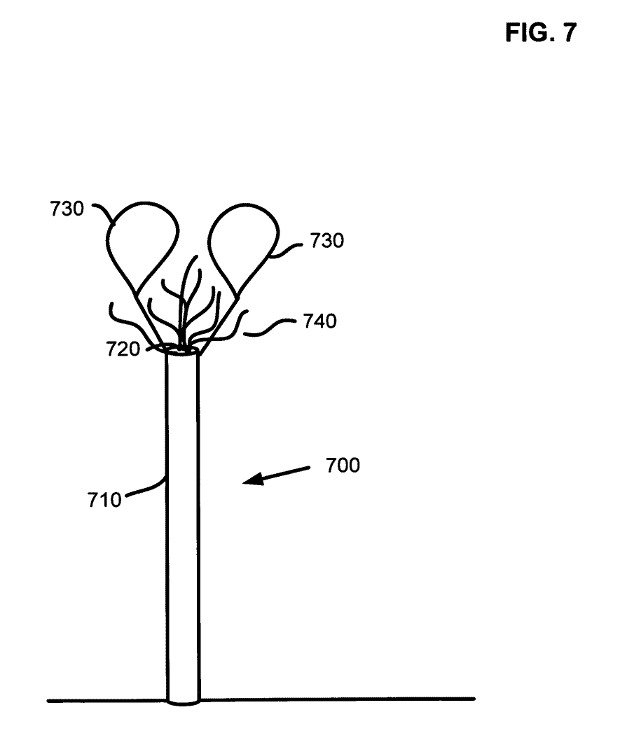

Referring now to FIG. 7, another exemplary embodiment of a conduit 700 is depicted. Conduit 700 may comprise an outer wall layer 710 which defines an elongated lumen 720. Conduit 700 may be held aloft by one or more balloons 730 or other devices used to maintain conduit 700 in an upright position. Other such devices may include but are not limited to airfoils, parafoils, and kites or other aerodynamic lifting surfaces; propellers, rockets, and jets or other thrust providing devices. Yet other structures for keeping conduit 700 aloft include momentum coupling to a vertically moving mass stream, such as but not limited to electric or magnetic coupling to moving projectiles or drag or thrust coupling to gas or liquid flows. Further, conduit 700 may be a double walled conduit as discussed earlier which provides additional buoyancy in combination with balloons or other lifting devices.

In an exemplary embodiment the carrier such as balloons 730 contain Hydrogen gas, Helium gas, heated gas, an exhaust gas, or other lighter than atmospheric air gas. In an exemplary embodiment an introducer pressurizes the gas into a space in the one or more carrier. This pressurized gas may be carried from ground level through a tube or the like. Conduit 700 may be used in the same manner as the conduits described above to expel material into the atmosphere at high altitudes to affect local or global atmospheric change. Such atmospheric change may also include the process of inducing precipitation by cloud seeding.

In another exemplary embodiment conduit 700 may be a hose or a series of hose segments which are coupled to the carrier on one end and coupled to a pump at or near the Earth's surface. In one embodiment, multiple pumps may be used along the length of conduit 700. Also, in another embodiment, conduit 700 may include support cabling or tether cabling, the support or tether cabling may also double as power delivery cabling to one or more devices along the length of conduit 700.

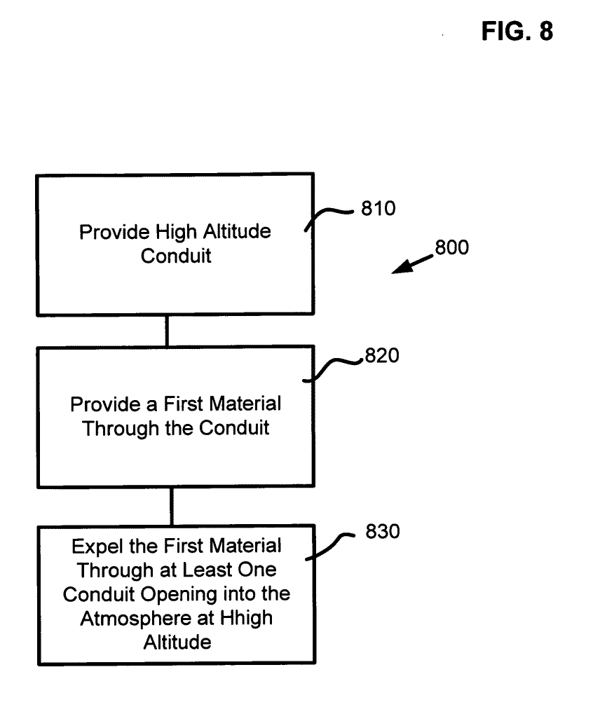

Referring now to FIG. 8, a process 800 of affecting atmospheric change is depicted. Process 800 includes providing a high altitude conduit extending upward into high altitudes (process 810). The process also includes providing a first material through the conduit (process 820). The material will include at least in part, the substances which are effective in creating the atmospheric change desired. Process 800 further includes expelling the first material through at least one conduit opening into the atmosphere at high altitude (process 830). Once expelled into the atmosphere, the materials will be carried and distributed by high altitude winds.

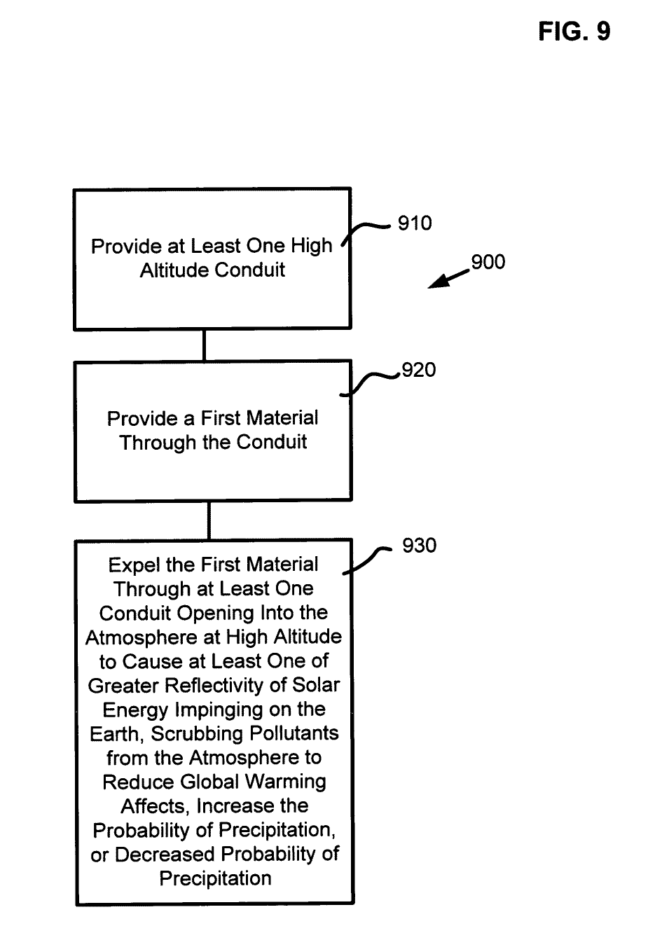

Referring now to FIG. 9, a process 900 of affecting terrestrial temperature change is depicted. Process 900 includes providing at least one high altitude conduit (process 910). In addition to the single conduit many conduits may be provided. These may be distributed in a small area, a region, within a country, within a group of countries, or worldwide, depending on the desired results and the application. Process 900 also includes providing a first material through the conduit (process 920). The material will include at least in part, the substances which are effective in creating the terrestrial temperature change desired. Process 900 further includes expelling the first material through at least one conduit opening into the atmosphere at high altitude to cause at least one of greater reflectivity of solar energy impinging on the earth or changing the amount of pollutants and/or carbon dioxide in the atmosphere to reduce global warming affects (process 930).

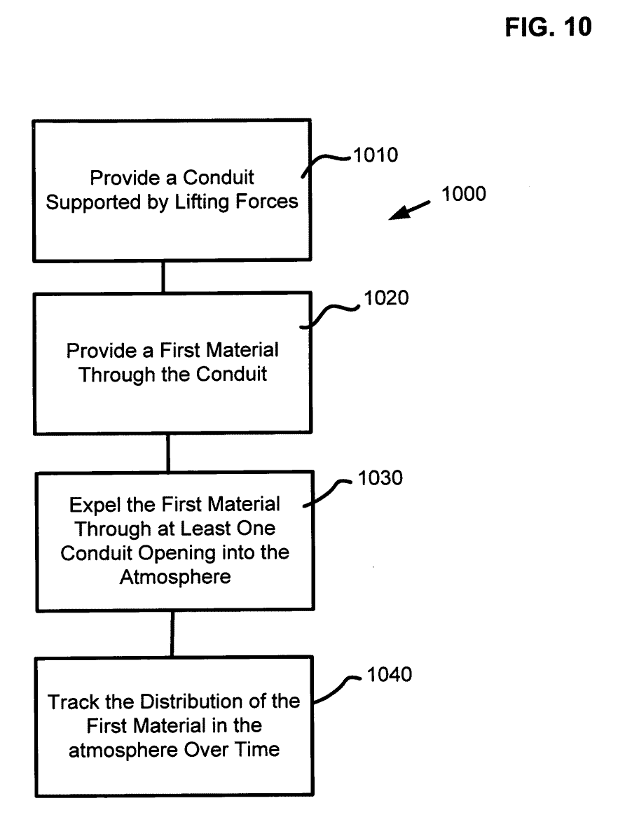

Referring now to FIG. 10, a process 1000 of determining the distribution of an aerosol in the atmosphere is depicted. The process includes providing a conduit supported by lifting forces (process 1010). The lifting forces may come from at least one of buoyancy effects of the high altitude conduit itself, aerodynamic lifting surfaces, propulsive devices, or at least one carrier. Process 1000 also includes providing a first material through the conduit (process 1020) and expelling the first material through at least one conduit opening into the atmosphere (process 1030). Once the material has been aerosolized and expelled into the atmosphere process 1000 includes tracking the distribution of the first material in the atmosphere over time (process 1040). This tracking of the aerosol may enable researchers or demonstrators of the technology to approximate or predict the distribution of aerosol when the conduit and related expelled materials are put into practice at the same or possibly higher altitudes. Tracking may be accomplished by any of a variety of ways, including but not limited to putting dyes (e.g. fluorescing dyes) into the expelled material. With dyes in the expelled material, imaging equipment either airborne, earthbound, or spaceborne may be used to track the dispersal and/or distribution of the expelled material. In accordance with exemplary embodiments, the tracking techniques may be applied to control of a high altitude system as well as for use in demonstration and testing at lower altitudes.

In accordance with one exemplary embodiment, the desired effect may be to scatter light by injecting particles into the atmosphere effectively increasing the Earth's albedo. In another exemplary embodiment, it may be desirable to use anthropogenic aerosols to cause reflectivity changes. This indirect effect is known as the Twomey effect. Aerosols may act as cloud condensation nuclei and thereby leading to greater numbers of smaller droplets of water. Large numbers of smaller droplets of water or other substances can diffuse light more efficiently than just a few larger droplets.

Particulate injection into the atmosphere may also result in changes in the particle size distribution in the atmosphere, which can affect atmospheric reflectivity properties. Anthropogenic particulates are therefore one candidate to affect global dimming, which may act to offset some of the effects of global warming. Examples of anthropogenic particulate includes but is not limited to metals, dielectrics, and combinations of these. Examples of metals include but are not limited to aluminum, gold, and titanium. Examples of dielectrics include but are not limited to sulfates, halides, and carbon compounds.

Conventionally, it is believed that the effect of global dimming is probably due to the presence of aerosol particles or particulates in the atmosphere. Aerosol particles and particulates scatter incident solar energy and reflect sunlight back into space. Particulates can also become nuclei for cloud droplets. It is thought that the water droplets in clouds coalesce around the particulates. Increased particulates, creates clouds consisting of a greater number of smaller droplets, which in turn makes them more reflective, thereby reflecting sunlight back into space.

Clouds intercept both heat from the sun and heat radiated from the Earth. Their effects vary in time, location and altitude. Usually during the daytime the interception of sunlight predominates, giving a cooling effect; however, at night the re-radiation of heat to the Earth slows the Earth's heat loss. Usually for high altitude clouds, the re-radiation of heat from the Earth predominates, leading to increased warming. Usually for low altitude clouds, the reflection of sunlight predominates leading to increased cooling. In one exemplary embodiment therefore, it may be beneficial to nucleate high altitude clouds to reduce the amount of heat re-radiation. In other exemplary embodiments it may be beneficial to nucleate low altitude clouds to increase reflection of sunlight. In other exemplary embodiments, it may be desirable to inject into the atmosphere either materials that absorb energy from the sun or materials that scatter, absorb, or reflect thermal radiation. In one exemplary embodiment it may be desirable to increase the absorption of solar radiation by the Earth's atmosphere in order to increase or upwardly influence terrestrial temperatures. Such absorption may be accomplished by the addition of water droplets in the air that may contain impurities such as soot or other materials. Also, carbonaceous materials may also be advantageous. Further, materials containing one or more optical absorbers such as dyes, direct band-gap semiconductors, or metal oxides may also be advantageous. Further still, particles may be designed having various colors, optical cross sections, sizes and/or geometries in order to accomplish given performance objectives.

Some climate scientists have theorized that aircraft contrails (also called vapor trails) are implicated in global dimming, but the constant flow of air traffic previously meant that this could not be tested. The near-total shutdown of civil air traffic during the three days following the Sep. 11, 2001 attacks afforded a rare opportunity in which to observe the climate of the USA absent from the effect of contrails. During this period, an increase in diurnal temperature variation of over 1° C. was observed in some parts of the US, i.e. aircraft contrails may have been raising nighttime temperatures and/or lowering daytime temperatures by much more than previously thought. Therefore, in one exemplary embodiment the process of creating atmospheric change may be characterized as changing the opacity of the atmosphere.

In yet another exemplary embodiment, halides may be used to affect global dimming. A halide is a binary compound, of which one part is a halogen atom and the other part is an element or radical that is less electronegative than the halogen, to make a fluoride, chloride, bromide, iodide, or astatide compound. Many salts are halides. All Group 1 metals form halides with the halogens and they are white solids. As stated earlier, it may be possible to harvest halides from the ocean to be expelled through a high altitude conduit as a mist. This injection may be done using dry halides or wet halides, e.g. sea water droplets or mist. Alternatively pseudohalides may also be used to affect global dimming. Pseudohalides resemble halides in their charge and reactivity. For example azides NNN—, isocyanate —NCO, Isocyanide, CN—, are examples of pseudohalides. This process of global dimming utilizes one or more of the aforementioned materials or other materials to scatter or reflect solar radiation impinging on the Earth's atmosphere. In other exemplary embodiments it may be desirable to use similar materials and/or techniques to reflect, scatter, or absorb reradiated thermal energy from the Earth's surface.

In accordance with another exemplary embodiment, the reflection or scattering of thermal radiation by the Earth's atmosphere may be accomplished by using natural or engineered particles that are expelled at high altitude including micro-wire structures or micro-crystalline structures that have mesh and/or lattices that have lattice sizes that are matched to the infrared wavelength range so that some of the infrared radiation is reflected by the Earth's atmosphere containing these particles. Many other geometries, sizes, materials, and shapes may similarly be used.

In accordance with yet another exemplary embodiment, the absorption of thermal radiation by the Earth's atmosphere may be accomplished by using natural or engineered particles that are expelled at high altitude. Such particles may contain materials with high absorptivity for thermal radiation wavelengths, such as carbonaceous materials, or narrow band-gap semiconductors, such as indium antimony (InSb), Indium Arsenic (InAs), lead telluride (PbTe), or similar materials.

In yet still another exemplary embodiment it may be desirable to scavenge carbon dioxide from the atmosphere by expelling carbonate aerosols into the atmosphere. The carbonate aerosols may combine to form carbonic acid droplets in the atmosphere. The carbonic acid undergoes disassociation to bicarbonate and carbonate ions before precipitating to the ground. This scavenging process is not limited to the chemicals disclosed, but other chemicals having similar properties may also be applied.

In yet a further exemplary embodiment, cloud seeding, which is a form of weather or atmospheric modification, is an attempt to change the amount or type of precipitation that falls from clouds, by dispersing substances into the air that serve as cloud condensation or ice nuclei. The conventional intent is to increase precipitation, but hail suppression may also be accomplished. The most common chemicals used for cloud seeding include but are not limited to silver iodide and dry ice (frozen carbon dioxide). The expansion of liquid propane into a gas, causing liquid water to freeze into ice crystals that may fall out as snow, is being used on a smaller scale. Hygroscopic materials, such as salt, may also be used.

In mid-latitude clouds, the usual seeding strategy has been predicated upon the fact that vapor pressure is lower over water than over ice. When ice particles form in supercooled clouds, the ice particles are allowed to grow at the expense of liquid droplets. If there is sufficient growth, the particles become heavy enough to fall as snow (or, if melting occurs, rain) from clouds that otherwise would produce no precipitation. This process is known as “static” seeding.

Seeding of warm-season or tropical cumuliform (convective) clouds seeks to exploit the latent heat released by freezing. This strategy of “dynamic” seeding assumes that the additional latent heat adds buoyancy, strengthens updrafts, ensures more low-level convergence, and ultimately causes rapid growth of properly selected clouds.

In another exemplary embodiment, cloud seeding may be used to reduce precipitation. This may be accomplished by the creation of downdrafts in cumulonimbus clouds leading to the dynamic destruction of the cumulonimbi. In an exemplary embodiment the tops of the clouds may be seeded with a powdery material which causes downdrafts within the clouds. Also, other substances may be used including but not limited to water which is dispersed into the tops of the cumulonimbi.

Conventionally cloud seeding chemicals may be dispersed by aircraft or by dispersion devices located on the ground (generators). In the exemplary embodiments described, the chemicals may be transported and expelled at high altitudes through the high altitude conduit structures described above.

Aerosols in the stratosphere tend to migrate toward the poles. Thus aerosols injected for the purpose of reflecting incoming sunlight at or near the Arctic Circle would be expected to cool the Arctic but to have little or no effect on sunlight received by the temperate and tropical parts of the Earth. Aerosols injected into the atmosphere above Antarctica will similarly tend to disperse gradually toward the South Pole. To cover the entire planet, the spray would have to be released at a variety of latitudes, including sites near the equator.

The general poleward migration of high-altitude aerosols is useful for two reasons. First, it allows small-scale testing of a geoengineering system. In an exemplary embodiment, a pilot project could be set up in northern Alaska or northern Europe, for example.

Second, the polar regions have so far experienced far greater warming than has the rest of the planet, and some climate models project that this trend will continue. If a climate emergency occurs that would warrant use of geoengineering, it seems probable that it will affect the Arctic or Antarctic ice caps first and more severely. Systems that can concentrate their cooling effects to the northernmost or southernmost parts of the planet may thus be more useful in certain situations than those that only work uniformly on the entire Earth at once.

To estimate how much sunlight would need to be reflected to offset greenhouse warming of the Arctic or of the entire planet, scientists have turned to the same computer models that they use to project climate change scenarios. Some of these models suggest that reducing incoming solar radiation by about 1.8% worldwide would offset the greenhouse warming caused by the doubling of CO₂ concentration from its level in preindustrial times. (The CO₂ concentration is currently about 1.4 times its preindustrial level and rising steadily.

Preliminary modeling studies suggest that two million to five million metric tons of sulfur dioxide aerosols (carrying one million to 2.5 million tons of sulfur), injected into the stratosphere each year, would reverse global warming due to a doubling of CO₂, if the aerosol particles are sufficiently small and well dispersed. Two million tons equates to roughly 2% of the SO₂ that now rises into the atmosphere each year, about half of it from manmade sources, and far less than the 20 million tons of sulfur dioxide released over the course of a few days by the 1991 eruption of Mount Pinatubo. Scientific studies published so far conclude that any increase in the acidity of rain and snow as several million additional tons a year of SO₂ precipitate out of the atmosphere would be minuscule and would not disrupt ecosystems.

Because about 10% of the planet lies north of 60° N—which is roughly the latitude of Anchorage, Ak. or Oslo, Norway—a rough first-order estimate is that injection of as little as 200,000 metric tons a year of sulfur dioxide aerosol into the stratosphere above this region could offset warming within the Arctic. A phenomena peculiar to the polar atmosphere, the polar stratospheric vortex, adds uncertainty to this estimate, however. The vortex causes mixing between stratospheric air and the lower part of the atmosphere to occur more rapidly in the Arctic than at lower latitudes. As a result, aerosol particles injected into the stratosphere at latitudes above 60° N will probably fall back to Earth in less than a year, on average. To compensate for this effect—and because the aerosols serve no purpose during the dark polar winter—it would thus make sense, in accordance with one exemplary process, to concentrate the injection period to just the spring, so that the cooling effect is at maximum strength during the summer melting season.

An exemplary system could raise 100,000 tons of liquid a year from the ground to an elevation of 30 kilometers (100,000 feet).

When pumped continuously through a conduit, that amounts to about 3.2 kilograms per second and, at a liquid SO₂ density of 1.46 grams per cubic centimeter, about 34 gallons (150 liters) per minute. In comparison a garden conduit with a ¾-inch inner diameter can deliver liquid that fast.

It takes about 30 trillion Joules of potential energy to lift 100,000 tons of liquid SO₂ to a height of 30 kilometers. If the work is spread out over the course of a year, however, that energy translates to a required power of about 1,000 kilowatts. Inefficiencies and other practical considerations will increase this amount, possibly by several times; nonetheless, the power levels are not in the range of conventional industrial standards.

To pump 34 gallons a minute up a 30-kilometer-long conduit, the system must overcome both the gravitational head and the flow resistance. The gravitational head, which is simply another way of talking about the potential energy considered previously, would amount to a pressure of 4,300 bar (62,000 p.s.i.) if the liquid has a constant density of 1.46 g/cm³—not taking into account the small attenuation in the strength of gravity with increasing altitude.

The density of the SO₂ does not remain constant during its journey through the conduit, however. That transit takes enough time that at any point in length of the conduit, the temperature of the liquid inside the conduit is not too far from the temperature of the air outside it, although friction from the flow will impart some heat to the fluid. Air temperature drops with altitude, and so will the temperature of the SO₂; the density of the liquid thus increases with altitude. The magnitude of the density change will vary depending on the site of the high altitude conduit as well as the season and time of day, but we can use the thermal profile of the Standard Atmosphere to estimate a typical value: between 1.40 g/cm³ and 1.57 g/cm³. This density range from bottom to top produces an overall gravitational head of 4,520 bar.

It may be simpler to control the second kind of impediment, flow resistance. This pressure arises from drag forces imposed on the fluid by the walls of the pipe. By selecting the diameter of the conduit and other design characteristics, it may be chosen as to whether the flow resistance pressure is much greater than the gravitational head or much less than it. A lower flow resistance may seem always preferable, but it comes at a price: a larger diameter conduit, which means more mass for the buoyant or lifting carriers to support.

The weight of both the conduit itself and the fluid it contains increase quickly as conduit diameter expands. Consider two designs, one using a conduit with a diameter of ⅝-inch (1.6 cm), the other a conduit 1½ inches (3.8) in diameter. The ⅝-inch conduit has a cross-sectional area of 1.98 cm₂, which means that the flow velocity at the ground must be 11.4 m/s to achieve the required 34 gallons per minute delivery rate. (The flow velocity for this conduit drops to 10.2 m/s at higher altitudes due to cooling of the SO₂.)

To calculate the resulting flow resistance, factor in the flow's Reynolds number and also the effect of pipe roughness. Assume a wall roughness of ½ mil (13 micron). The Reynolds number, like density, is a function of temperature and thus altitude. It changes along the conduit by more than a factor of two—from 320,000 to 810,000—due to the temperature-induced gradients in density, viscosity, and velocity.

This variation in the Reynolds number has very little effect. The flow resistance remains essentially constant along the conduit, ranging from 1,000 to 1,100 bar/km. The total flow-induced pressure head for the ⅝ inch conduit is thus 30,800 bar, much larger than the 4,500 bar gravitational head. For a ⅝-inch conduit, drag forces thus largely determine our pumping power.

In contrast, a 1½-inch conduit can deliver the payload at a flow rate under 2 m/s, which generates a markedly smaller flow resistance of just 360 bar. The price for this huge reduction in pumping requirements is, of course, the need to generate more lift to support a heavier conduit. The SO₂ alone in the ⅝-inch conduit weighs 9.1 tons, whereas the liquid in the 1½-inch conduit comes to 52.5 tons. The larger-bore conduit will also weigh more than the thin conduit, but that difference is at least partially offset by the need to install more pumps (and electrical cable to run them) along the length of the thin conduit. The choice of the optimum conduit diameter thus requires a complex set of design tradeoffs (see Table 1).

TABLE 1
Options for a High Altitude Conduit Pumped from the Ground

| | Gravita- | | | | Mass of |
|---|---|---|---|---|---|
| Conduit | tional | Flow | Total | | fluid-filled |
| diameter | head | resistance | pressure | SO₂ Mass | conduit |
| (cm) | (bar) | (bar) | (bar) | (metric tons) | (metric tons) |
| 2.0 | 5,470 | 15,600 | 21,060 | 17.5 | 31.7 |
| 2.5 | 5,280 | 6,480 | 11,760 | 26.5 | 39.0 |
| 3.0 | 5,170 | 3,160 | 8,330 | 37.3 | 50.2 |
| 3.5 | 5,100 | 1,720 | 6,830 | 50.1 | 64.5 |
| 4.0 | 5,070 | 1,020 | 6,090 | 65.0 | 81.6 |
| 4.5 | 5,050 | 640 | 5,690 | 81.9 | 101.5 |

Instead of relying solely on a big pump on the ground, a series of pumps could be placed at intervals along the conduit. Large pressures and fluid compressibility then cease to be concerns, and the conduit can be lighter and have thinner walls. Each pump need deliver only modest pressure, and we could build extras into the chain so that the system can tolerate occasional pump failures. The total mass requiring support will be greater than what is shown in table 2, however, because it will include the additional weight of the pumps themselves as well as the electrical cables that power them.

TABLE 2
Options for a High Altitude Conduit with Airborne Pumps

| | Gravita- | | | | Mass of |
|---|---|---|---|---|---|
| Conduits | tional | Flow | Total | | fluid-filled |
| diameter | head | resistance | pressure | SO₂ Mass | conduit |
| (cm) | (bar) | (bar) | (bar) | (metric tons) | (metric tons) |
| 2.0 | 4,520 | 18,810 | 23,330 | 14.5 | 15.4 |
| 2.5 | 4,520 | 7,550 | 12,070 | 22.6 | 23.8 |
| 3.0 | 4,520 | 3,610 | 8,130 | 32.6 | 34.0 |
| 3.5 | 4,520 | 1,940 | 6,460 | 44.3 | 46.0 |
| 4.0 | 4,520 | 1,140 | 5,660 | 57.9 | 59.9 |
| 4.5 | 4,520 | 720 | 5,240 | 73.3 | 75.6 |

The total pumping power required for the distributed approach is, of course, very similar to that for a ground-based pump, but there are small differences. The absence of compressibility reduces the gravitational head, but for low diameter conduits this effect is more than offset by the fact that denser fluid requires lower flow velocities and hence incurs less flow resistance.

Given all these options, a support system would be straightforward to design—if only there were no wind. Unfortunately, winds at altitude are strong, often blow in different directions at different altitudes, and can change speed and direction rapidly. The need to deal with the static and dynamic forces imposed by wind will greatly influence the design of the conduit's aerial support.

An efficient way structurally to help a long, thin object such as the conduit resist sideways deflection by the wind is to draw it taut—exactly what a giant balloon at the top would do. Moreover, the strongest and most variable winds do not occur in the stratosphere, but at intermediate altitudes of around 10 kilometers (33,000 feet)—altitudes where one might distribute smaller support balloons. Lofting balloons in the windiest part of the atmosphere will expose the system to more wind stress.

Wind speeds generally increase in altitude, reaching values around 60 m/s at heights of 10 to 15 kilometers. When convolved with the atmospheric density profile, the dynamic pressures generated by the wind peak at roughly 1,000 Pa in the vicinity of 10 km altitude.

The wind pushes both the balloons and the conduit itself. These should be thus designed to minimize drag and to present the smallest cross-section to the wind achievable (particularly for segments near 10 km altitude, where the wind forces are highest).

The balloons pose the greater challenge because of their larger lateral area: a single spherical balloon 35 meters in diameter presents about 1,000 m² of area to the wind, for example, which is about the same lateral area as the entire length of a conduit 3 centimeters wide and 30 km long. Omitting balloons from the conduit in the region around 10 km altitude would reduce the dynamic pressure on the system. But if the conduit is denuded of balloons in its middle, the balloons at higher altitudes must be correspondingly larger.

To illustrate the tradeoff, let's compare two designs for supporting a high altitude conduit that includes a conduit 3 cm in diameter, pumped solely from the ground. Assume the balloons must support the full 50 tons of the lofted structure plus the SO₂ payload, not just the weight of the empty conduit.

The first design balances lift and weight locally, as they vary along the conduit, by placing balloons of appropriate size every half kilometer. The balloons range in diameter from 15 meters at the base to 56 meters at the top. Altogether, the balloons present an aggregate lateral area of 30,000 m² to the wind—30 times the area of the conduit itself. When convolved with the dynamic wind pressure, the aggregate side force (for a drag coefficient of 1) is 3.3 MNwt, which is more than six times the weight of the conduit.

The second design balances lift and weight globally, by placing balloons only near the top of the conduit, at a spacing of a half kilometer between the altitudes of 20 and 30 km. The balloons in this design are larger, ranging in diameter from 50 meters to 85 meters. Altogether, their aggregate lateral area is 45,000 m², 50% larger than in the first case. When convolved with the dynamic wind pressure, however, the aggregate side force (again for a unit drag coefficient) is only 2.5 MNwt, about one quarter lower than in the first design. The side force is still much greater than the weight of the conduit, however. Clearly we must find some way to drastically reduce the wind load.

One redeeming feature of wind forces is that they can provide aerodynamic lift as well as drag. It may therefore be advantageous using kites or other lifting airfoils to help support the conduit. Although they wouldn't function all the time, they would provide lift at precisely the times it is most needed—when the wind is severe and pushing the conduit sideways.

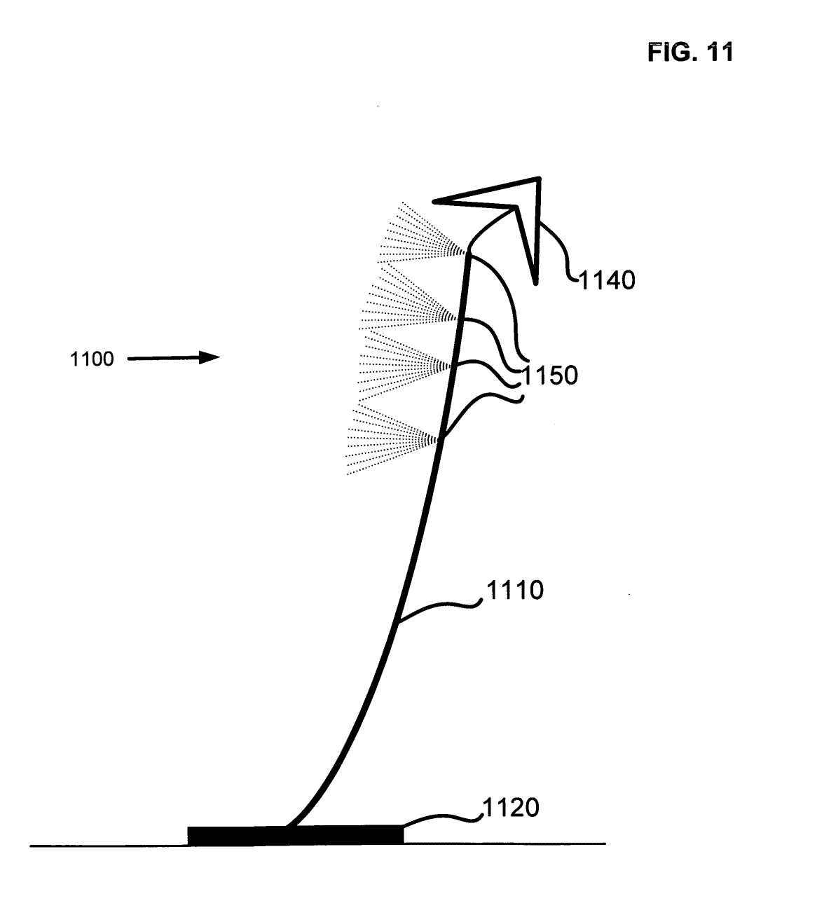

Another exemplary solution may be to use buoyant lifting bodies, such as elongated balloons shaped like aerodynamic blimps rather than squat pumpkins. The balloons themselves can then combine the functions of static and dynamic lift. Alternatively, it may be advantageous to use an airfoil shaped buoyant body such as is depicted in FIG. 11. A system 1100 for delivering particulate into the atmosphere ground. System 1100 includes a lifting buoyant body 1140 tethered to conduit 1110. Buoyant lifting body 1140 may come in a variety of shapes and sizes depending on the design constraints and tradeoffs. Depicted in FIG. 11 is an inflatable swept back wing that provides both buoyancy and, in the proper wind conditions, will generate lifting forces as well. A series of one or more sprayers or atomizers are located along the length of conduit 1110.

This approach offers three major advantages. First, an elongated shape presents a much smaller frontal area to the wind for any given interior volume. Second, and even more important, is a reduction to the drag coefficient: for a typical blimp this is about 0.05, 1/20th that of a pumpkin-shaped balloon. Finally, blimps can be designed to generate aerodynamic lift that greatly exceeds the drag force. JP Aerospace has designed large V-shaped blimps that reportedly can generate 20 times as much lift force as the drag imposed by incident wind. The company has even constructed prototypes. Although a high ratio of lift to drag doesn't actually reduce the lateral force imposed by the wind, it would increase the conduit tension, thereby reducing the deflection caused by the wind.

The one clear disadvantage of using blimp-like balloons is that they are less structurally efficient than pumpkin-shaped designs. That is, they have more wall mass per unit of buoyant lift, so they must be larger and made from more envelope material. These are affordable penalties, however, particularly since the gains in aerodynamic lift more than offset the losses in buoyancy.

The drag coefficient of the conduit may similarly reduced by giving it a streamlined shape or by surrounding it with a low-mass aerodynamic sheath. In either case, the wind will automatically twist the conduit into the proper, drag-minimizing, orientation.

It seems clear that sensible use of well understood strategies for producing aerodynamic lift and reducing aerodynamic drag can enable a high altitude conduit system to tolerate wind forces with only modest (albeit highly dynamic) deflection of the conduit.

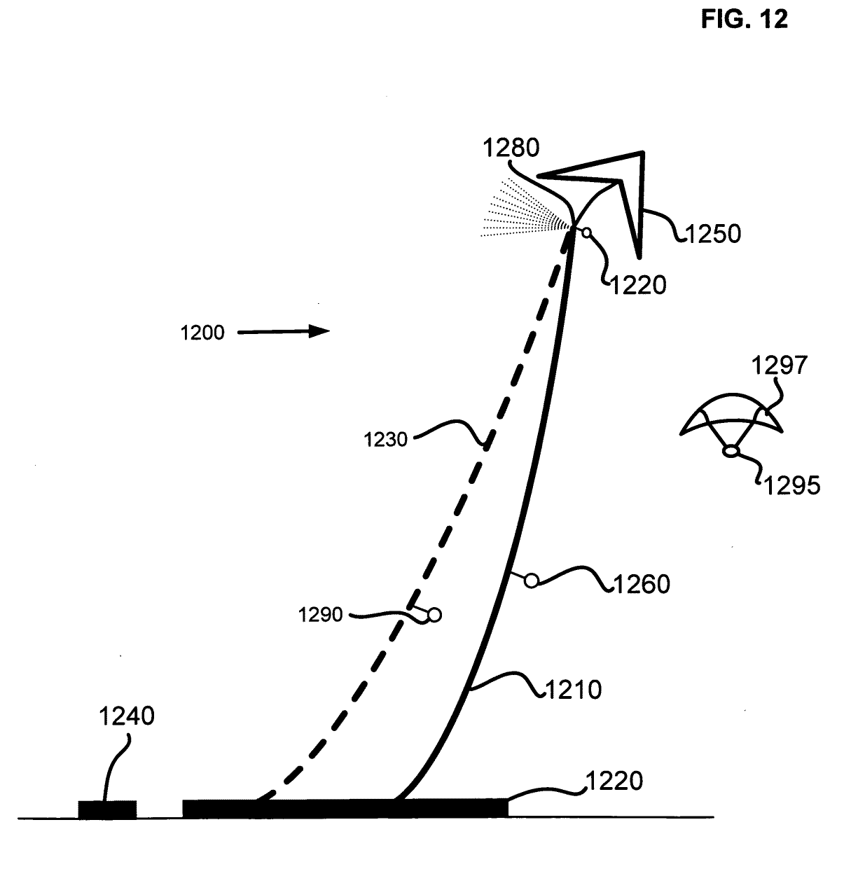

A high altitude “elevator” system 1200 may be another alternative for lifting mass to the stratosphere as depicted. Like the conduit, it would use one or more lighter-than-air structures 1250 for holding the track in FIG. 12 tethered to the ground at a base 1220 and a dispersal system 1280 at the top of the tether or track 1210, nominally at 30 km altitude. The elevator or payload carrier 1260, however, would carry the payload liquid in discrete tanks carried by vehicles (“climbers”), which crawl up the tether cable or track 1210.

The main advantage that an elevator offers over a conduit is the elimination of flow resistance. In principal, an elevator could transport liquids much more quickly than a conduit of equivalent static capacity. It is certainly reasonable to imagine designing a vehicle that climbs a cable at tens of meters per second, in contrast to the few meters per second envisioned above for a 1½-inch (3.8-centimeter) conduit.

We could consider many design options for a stratospheric elevator system. Motive power could be delivered mechanically by a continuous loop of moving cable (similar to a ski lift) or by a winch; or via electric traction, using external power from the cable or beamed from the ground; or by self-powered motors on the vehicles themselves.

The system could use just one large-capacity climber or several smaller vehicles. A single-car system is simpler. Increasing the number of cars keeps the load on the cable closer to constant, however, as well as more evenly distributed. Multiple vehicles could travel on a single cable 1210 if “sidings” were placed to allow up- and down-traveling vehicles to pass one another.

Other options include:
vehicles 1295 that simply drop from the top of the cable and fall or glide back to Earth when empty using a parachute, wing, or by other means;
a separate cable 1220 may be used for guiding payload carrier 1290 coming down. A challenge with this approach would be keeping cables from tangling or vehicles from colliding, unless the cables were very widely space at the ground.

The simplest option may be to send a single self-powered climber up and down a single stationary cable. The most efficient option is likely a “conveyor belt” with an endless loop of cable carrying many small tanks. The latter would require a large amount of engineering development, however.

The first choice of powerplant for a self-powered climber may be a turboshaft engine—or perhaps a lightweight, turbocharged piston engine—driving the vehicle mechanically.

Other options include:
a monopropellant or bipropellant turbogenerator, e.g., using hydrogen peroxide plus a small amount of hydrocarbon fuel;
an air-breathing turbogenerator that operates from sea level to 15-18 km, at which point high-specific-energy lithium batteries provide main propulsive power;
high-efficiency electric motors driven exclusively by battery power.

A climber powered solely by batteries, if it is reasonably efficient, could climb to 30 km with about 50% payload fraction (˜200 Wh/kg=720 kJ/kg=2.4 kg lifted to 30 km per 1 kg of battery). Outfitted with a lightweight motor to provide power for the first 15 km, it could have a payload fraction of about 70%. For long-term use of a battery-powered climber, however, batteries would have to endure many more than 1,000 charge-discharge cycles. If such options were not available, then a laser- or microwave-beamed power system, or a moving cable, would offer the next most attractive and cost-effective approaches.

Finally, consider what kind of cable would be required by a 30 km elevator. Zylon or similar cable of 1 cm² thickness offers a usable tensile strength (with safety margins) of 2 GPa and a load rating of 20,000 kg at a cable mass of 156 kg/km (so 4,700 kg for 30 km). It may be necessary to use multiple thinner cables interconnected by webbing to provide both protection from single-point breaks and additional traction area. Indeed, this is similar to the “ribbon” configuration developed for space elevators.

Assume a top station (tanks, tank swap mechanism, sprayer) 1280 coupling a payload carrier 1270 thereto that weighs one metric ton, then the total mass to be lifted is 15,700 kg. That is less than one third of the weight of a conduit system pumped solely from the ground.

A slightly more sophisticated elevator system capable of maintaining climb speeds of 50 m/s—or one that includes a relay station at around 15 km altitude so that two climbers can travel at once—could substantially reduce the cycle time and thus the system mass. A 6,000 kg vehicle and 10,000 kg total system weight would be a reasonable goal.

An elevator could offer other advantages over a conduit besides lower weight. It would be easier to unload the system quickly in the event of high winds aloft or low-altitude storms. Unloading a 30 km conduit might require more than an hour, compared to about 15 minutes for an elevator. A related advantage is the ease with which the system could be unloaded at night in order to reduce load on the balloons and maintain constant altitude. An elevator system may also be easier to prototype at small scale (e.g. 10,000 tons per year delivery rates), whereas flow resistance makes this difficult to do with a long conduit.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, hovercraft, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Quest, Southwestern Bell, etc), or (g) a wired/wireless services entity such as Sprint, Cingular, Nextel, etc.), etc.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of affecting atmospheric change, comprising:
providing a high altitude conduit supported by lifting forces and buoyancy forces generated by at least one buoyant lifting body coupled to the high altitude conduit;
providing a first material through the conduit; and
expelling the first material through at least one conduit opening into the atmosphere at high altitude.

2. The method of claim 1, wherein the buoyant lifting body includes a wing.

3. The method of claim 1, wherein the buoyant lifting body includes a lift generating surface.

4. The method of claim 1, wherein the buoyant lifting body includes an inflatable lift generating surface.

5. The method of claim 1, wherein the buoyant lifting body includes a buoyant lift generating surface.

6. The method of claim 1, wherein the buoyant lifting body includes a buoyant wing.

7. The method of claim 1, wherein the buoyant lifting body includes an inflatable wing.

8. The method of claim 1, wherein the conduit cross section is configured to provide reduced drag as compared with a conduit with a uniform cross section.

9. The method of claim 1, wherein the conduit extends into the stratosphere.

10. The method of claim 1, wherein the first material at least partially includes a gas.

11. The method of claim 1, wherein the first material at least partially includes a fluid.

12. The method of claim 1, wherein the first material at least partially includes an aerosol.

13. The method of claim 1, wherein the first material at least partially includes solid particulate.

14. The method of claim 1, wherein the first material comprises at least one form of a sulfur oxide.

15. The method of claim 1, wherein the first material comprises at least one form of sulfate ion.

16. The method of claim 1, wherein the first material comprises a sulfate aerosol.

17. The method of claim 1, wherein the first material comprises materials which are designed to affect global dimming.

18. The method of claim 1, wherein the first material comprises chemicals which are designed to affect global dimming by increasing the reflectivity of sunlight by the atmosphere.

19. The method of claim 1, wherein the first material is extracted from a fossil fuel burning process.

20. The method of claim 1, wherein the material comprises at least one form of halide.

21. The method of claim 1, wherein the first material comprises at least one form of halide in solution.

22. The method of claim 1, wherein the first material comprises at least one form of pseudohalide.

23. The method of claim 1, wherein the first material comprises at least one form of halide mist.

24. The method of claim 1, wherein the first material is at least partially derived from sea water.

25. The method of claim 1, further comprising:
mixing a first material with a second material.

26. The method of claim 1, further comprising:
controlling the amount of the first material being expelled.

27. The method of claim 1, further comprising:
controlling the expelling to approach a predetermined amount of atmospheric change.

28. The method of claim 1, wherein the conduit extends at least one kilometers into the atmosphere.

29. The method of claim 1, wherein the conduit extends at least 10 kilometers into the atmosphere.

30. (canceled)

31. The method of claim 1, wherein the first material at least partially includes liquid sulfur dioxide.

32. A system for providing material to the atmosphere comprising:
an elongate conduit structure extending into the atmosphere and being held aloft by lifting forces and buoyancy forces generated by at least one buoyant lifting body coupled to the high altitude conduit;
an introducer configured to provide a first material into the interior of the conduit; and
at least one exit aperture configured to expel the first material into the atmosphere.

33-60. (canceled)

61. A method of delivering a payload, comprising:
providing at least one high altitude track supported by lifting forces, the lifting forces coming from at least one of buoyancy effects of a carrier, aerodynamic lifting surfaces, propulsive devices, or multiple carriers;
running a payload carrier along the track carrying a payload; and
expelling at least a first material from the payload into the atmosphere at high altitude.

62. The method of claim 61, further comprising:
causing at least one of greater reflectivity or increased scattering of solar energy impinging on the Earth's atmosphere.

63. The method of claim 61, further comprising:
causing spectrally dependent changes to at least one of the transmission of solar energy impinging on the Earth's atmosphere or the atmospheric transmission of terrestrial reradiation.

64. The method of claim 61, further comprising:
causing increased absorption of solar energy in the Earth's atmosphere.

65. The method of claim 61, further comprising:
causing at least one of increased reflectivity or increased scattering of terrestrial reradiation by the Earth's atmosphere.

66. The method of claim 61, further comprising:
causing increased absorption of terrestrial reradiation by the Earth's atmosphere.

67-69. (canceled)

70. The method of claim 61, wherein the first material at least partially includes a fluid.

71. The method of claim 61, wherein the first material at least partially includes an aerosol.

72. The method of claim 61, wherein the first material at least partially includes solid particulate.

73. The method of claim 61, wherein the first material comprises at least one form of a sulfur oxide.

74. The method of claim 61, wherein the first material comprises at least one form of sulfate ion.

75. The method of claim 61, wherein the first material comprises a sulfate aerosol.

76. The method of claim 61, wherein the first material comprises solid particulate and a fluid.

77. (canceled)

78. (canceled)

79. The method of claim 61, wherein the material comprises at least one form of halide.

80. The method of claim 61, wherein the first material comprises at least one form of halide ion in solution.

81. The method of claim 61, wherein the first material comprises at least one form of pseudohalide.

82. The method of claim 61, wherein the first material comprises at least one form of halide mist.

83. The method of claim 61, wherein the first material is at least partially derived from sea water.

84-89. (canceled)

90. A system for providing material to the atmosphere, comprising:
a track extending into the atmosphere and being held aloft by at least one of buoyancy forces or lifting forces of a carrier;
at least one payload carrier configured to run on the track and to carry a payload;
a delivery system configured to couple with the payload and expel at least a first material into the atmosphere at high altitude.

91-111. (canceled)
